(19) United States
(12) Patent Application Publication
(10) Pub. No.: US 2015/0170646 A1
(43) Pub. Date: Jun. 18, 2015

(54) CROSS-LANGUAGE RELEVANCE DETERMINATION DEVICE, CROSS-LANGUAGE RELEVANCE DETERMINATION PROGRAM, CROSS-LANGUAGE RELEVANCE DETERMINATION METHOD, AND STORAGE MEDIUM

(71) Applicants: Chihaya Fujii, Nagoya-shi (JP); Hiroto Hamada, Miyoshi-shi (JP); Shigeru Masuyama, Toyohashi-shi (JP); Hiroyuki Sakai, Musashino-shi (JP); Masanobu Tsuruta, Toyohashi-shi (JP); Miyoko Takao, Toyohashi-shi (JP)

(72) Inventors: Chihaya Fujii, Nagoya-shi (JP); Hiroto Hamada, Miyoshi-shi (JP); Shigeru Masuyama, Toyohashi-shi (JP); Hiroyuki Sakai, Musashino-shi (JP); Masanobu Tsuruta, Toyohashi-shi (JP); Miyoko Takao, Toyohashi-shi (JP)

(73) Assignee: TOYOTA JIDOSHA KABUSHIKI KAISHA, Toyota-shi, Aichi-ken (JP)

(21) Appl. No.: 14/406,002

(22) PCT Filed: Jun. 5, 2013
(86) PCT No.: PCT/IB2013/001162

§ 371 Date: Dec. 5, 2014

(30) Foreign Application Priority Data
Jun. 6, 2012 (JP) 2012-129310

(51) Int. Cl. G10L 15/22; G10L 15/08; G06F 17/30; G06F 17/28; G10L 15/18

(52) U.S. Cl. CPC G10L 15/22; G06F 17/28; G10L 15/18; G06F 17/30; G10L 15/08; G10L 2015/086; G10L 2015/088

(57) ABSTRACT

A cross-language relevance determination device includes: a database that stores data including a plurality of sentences; a relation determination unit that calculates the number of times a specific word has appeared between input two words in the database, and that determines whether the two words are conceptually in a hierarchical relation or in a parallel relation on the basis of a position of a coordinate having the calculated number of times as a coordinate value in an imaginary space having an axis that represents the number of appearances of the specific word.

### BACKGROUND OF THE INVENTION

1. Field of the Invention

The invention relates to a cross-language relevance determination device, a cross-language relevance determination program, a cross-language relevance determination method and a storage medium that determine a relevance between words.

2. Description of Related Art

Research has been conducted to obtain a relevance between words with the use of a computer. For example, there is known a system that includes a keyword extracting unit that extracts keywords from a plurality of document files and an index value calculation unit that calculates a relevance ratio between a pair of keywords for any combination of the keywords on the basis of an appearance frequency of each keyword in each document file and that stores each relevance ratio in a table DB (for example, see Japanese Patent Application Publication No. 2009-98931 (JP 2009-98931 A)). The index value calculation unit in this system calculates the appearance frequency of each keyword having an appearance history in each document file, calculates the square value of the appearance frequency of each keyword, accumulates the square values over all the document files, calculates the product of the appearance frequencies of a pair of the keywords in each document file, accumulates the products over all the document files, calculates the square root of the sum total of the square values of each keyword, adds both the square roots together, and divides the sum total of the products of the keywords by the sum of both square roots, thus calculating the relevance ratio.

However, the above-described existing system analyzes the relevance between keywords on the basis of only the concept that the relevance ratio, so it is not possible to appropriately determine the relevance between words in a hierarchical structure.

### SUMMARY OF THE INVENTION

The invention provides a cross-language relevance determination device, a cross-language relevance determination program, a cross-language relevance determination method and a storage medium that are able to appropriately determine a relevance between words in a hierarchical structure.

A first aspect of the invention provides a cross-language relevance determination device. The cross-language relevance determination device includes: a first database that stores data including a plurality of sentences; and a relation determination unit that calculates the number of times a specific word has appeared between input two words in the first database, and that determines whether the two words are conceptually in a hierarchical relation or in a parallel relation on the basis of a position of a coordinate having the calculated number of times as a coordinate value in an imaginary space having an axis that represents the number of appearances of the specific word.

A second aspect of the invention provides a cross-language relevance determination program for causing a computer to execute a method. The method includes: in a database that stores data including a plurality of sentences, calculating the number of times a specific word has appeared between input two words; and determining whether the two words are conceptually in a hierarchical relation or in a parallel relation on the basis of a position of a coordinate having the calculated number of times as a coordinate value in an imaginary space having an axis that represents the number of appearances of the specific word.

A third aspect of the invention provides a cross-language relevance determination method. The cross-language relevance determination method includes: in a database that stores data including a plurality of sentences, calculating the number of times a specific word has appeared between input two words; and determining whether the two words are conceptually in a hierarchical relation or in a parallel relation on the basis of a position of a coordinate having the calculated number of times as a coordinate value in an imaginary space having an axis that represents the number of appearances of the specific word.

A fourth aspect of the invention provides a non-transitory computer-readable storage medium storing a program for causing a computer to execute a method. The method includes: in a database that stores data including a plurality of sentences, calculating the number of times a specific word has appeared between input two words; and determining whether the two words are conceptually in a hierarchical relation or in a parallel relation on the basis of a position of a coordinate having the calculated number of times as a coordinate value in an imaginary space having an axis that represents the number of appearances of the specific word.

According to the above aspects, it is possible to appropriately determine a relation between words in a hierarchical structure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an example of the hardware configuration of a system according to a first embodiment of the invention;

FIG. 2 is a view that shows hierarchical data that are managed by a vehicle-side device;

FIG. 3 is an example of the functional configuration of the system according to the first embodiment of the invention;

FIG. 4 is an image view that conceptually shows that a relation determination unit determines whether two words are conceptually in a hierarchical relation or in a parallel relation;

FIG. 5 is an example of processing results of combinations between a newly added word “i-Pod” and each word that is included in the hierarchical data;

FIG. 6 is an example of upper-level candidate words extracted by an arrangement determination unit on the basis of the processing results shown in FIG. 5;

FIG. 7 is a view that shows a state where the arrangement determination unit determines arrangement of the newly added word on the basis of an average point of scores;

FIG. 8 is a view that shows a state where the arrangement determination unit arranges the newly added word to a lower level of the upper-level candidate word having the highest rate at which an index value* is larger than or equal to a threshold;

FIG. 9 is a view that shows a state where the arrangement determination unit arranges the newly added word to a lower level of the upper-level candidate word having the largest average of index values*;

FIG. 10 is a view that shows a state where the newly added word “i-Pod” is arranged at the lower level of “select source”;

FIG. 11 is an example of a flowchart that shows the flow of processes that are executed by a server device according to the present embodiment;

FIG. 12 is a view that simply shows the relationship among data included in teacher data, separating hyperplanes, a margin and a support vector in a two-dimensional space form;

FIG. 13 is view that simply shows the relationship among data included in teacher data, separating hyperplanes, a margin and a support vector in a two-dimensional space form in the case where a soft margin is employed;

FIG. 14 is an example of the functional configuration of a system according to a second embodiment of the invention;

FIG. 15 is an example of a flowchart that shows the flow of processes that are executed by a vehicle-side device according to the second embodiment;

FIG. 16 is an example of the functional configuration of a system according to a third embodiment of the invention; and

FIG. 17 is an example of a flowchart that shows the flow of processes that are executed by a vehicle-side device according to the third embodiment.

### DETAILED DESCRIPTION OF EMBODIMENTS

### First Embodiment

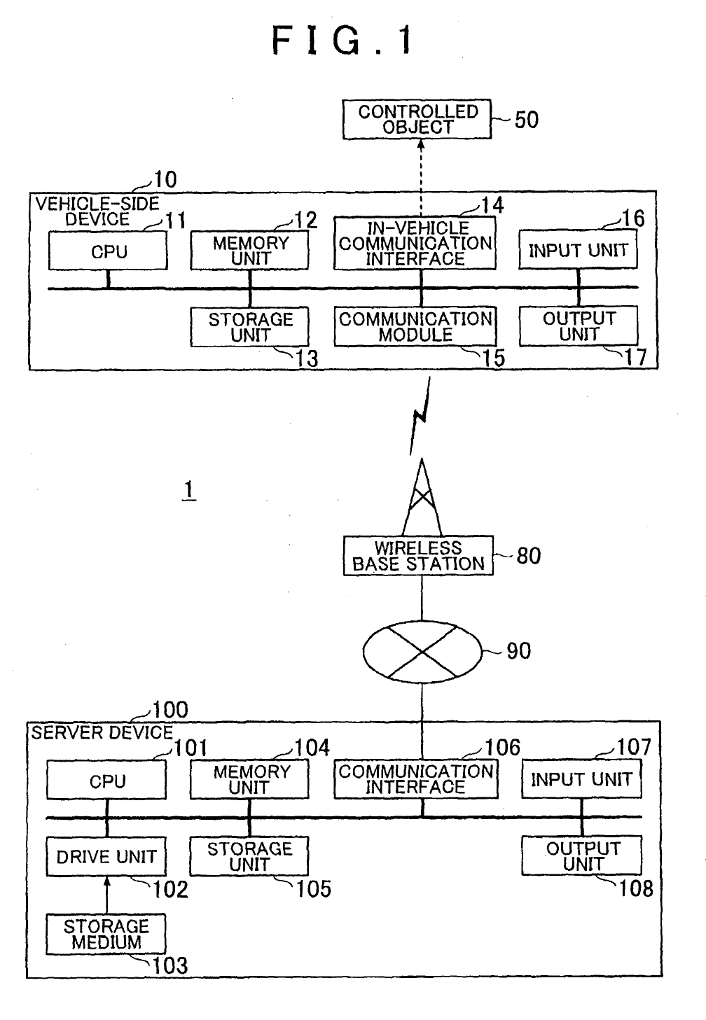

FIG. 1 is an example of the hardware configuration of a system 1 according to a first embodiment of the invention. The system 1 includes a vehicle-side device 10 and a server device 100. The vehicle-side device 10 is mounted on a vehicle. The server device 100 functions as a cross-language relevance determination device.

The vehicle-side device 10, for example, includes a central processing unit (CPU) 11, a memory unit 12, a storage unit 13, an in-vehicle communication interface 14, a communication module 15, an input unit 16 and an output unit 17. These components are connected to one another via a bus, a serial line, or the like. The vehicle-side device 10 may include a read only memory (ROM), a direct memory access (DMA) controller, an interrupt controller, or the like (not shown).

The CPU 11 is, for example, a processor that has a program counter, a command decoder, various computing units, a load store unit (LSU), a general purpose register, and the like. The memory unit 12 is, for example, a random access memory (RAM). The storage unit 13 is, for example, a hard disk drive (HDD), a solid state drive (SSD), or an electrically erasable and programmable read only memory (EEPROM). The in-vehicle communication interface 14, for example, communicates with a controlled object 50 using an appropriate communication protocol, such as a low-speed body-oriented communication protocol, a multimedia-oriented communication protocol and Flex Ray. The low-speed body-oriented communication protocol is typically a controller area network (CAN) or a local interconnect network (LIN). The multimedia-oriented communication protocol is typically a media oriented systems transport (MOST). The communication module 15, for example, communicates with the server device 100 via, for example, a radio wave network of mobile phones, a wireless base station 80 and a network 90. Such communication is allowed with the use of a separate mobile phone. In this case, the communication module 15 is an interface unit that carries out wireless or wired communication with the mobile phone. The input unit 16, for example, includes a touch panel, a switch, a button, a microphone, or the like. The output unit 17, for example, includes a display device (which may also serve as the touch panel), such as a liquid crystal display (LCD) and a cathode ray tube (CRT), a speaker, or the like.

The server device 100, for example, includes a CPU 101, a drive unit 102, a storage medium 103, a memory unit 104, a storage unit 105, a communication interface 106, an input unit 107 and an output unit 108. These components are connected to one another via a bus, a serial line, or the like. The server device 100 may include a ROM, a DMA controller, an interrupt controller, or the like (not shown).

The drive unit 102 is able to load programs and data from the storage medium 103. When the storage medium 103 in which programs are recorded is loaded into the drive unit 102, the programs are installed from the storage medium 103 to the storage unit 105 via the drive unit 102. The storage medium 103 is a portable storage medium, such as a compact disc (CD), a digital versatile disc (DVD) and a universal serial bus (USB) memory.

The memory unit 104 is, for example, a RAM. The storage unit 105 is, for example, an HDD, an SSD or an EEPROM.

Not only programs are installed into the server device 100 with the use of the storage medium 103 as described above but also programs may be installed into the storage unit 105 through downloading from another computer via a network with the use of the communication interface 106. The network in this case is, for example, the Internet or a local area network (LAN), and may include the network 90. Programs that are executed in the server device 100 may be prestored in the storage unit 105, the ROM, or the like, at the time of shipment of the server device 100.

The communication interface 106 controls, for example, connection to the network. The input unit 107 is, for example, a keyboard, a mouse, a button, a touch pad, a touch panel, a microphone, or the like. In addition, the output unit 108, for example, includes a display device, such as an LCD and a CRT, a printer, a speaker, or the like.

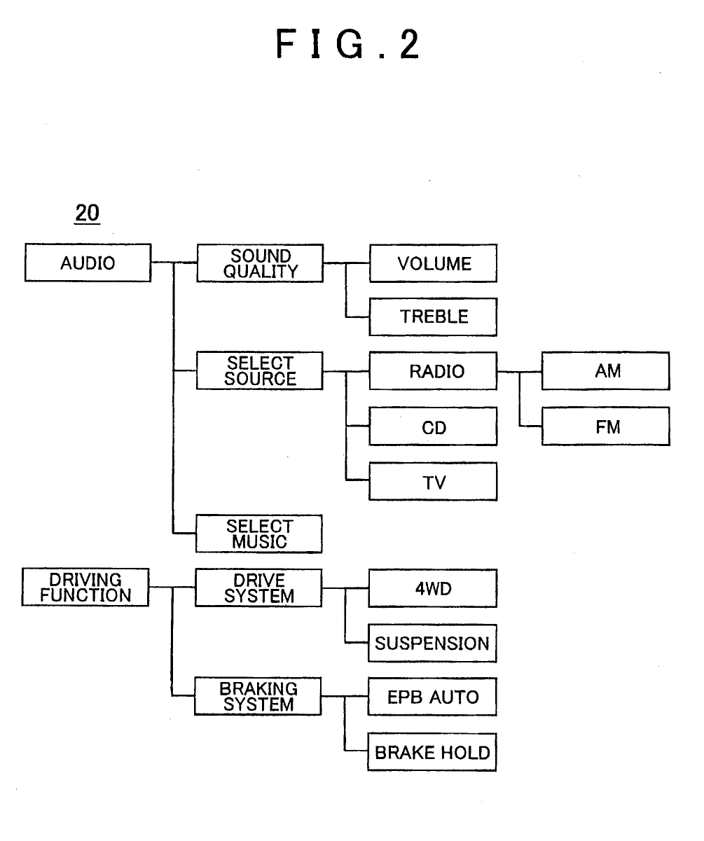

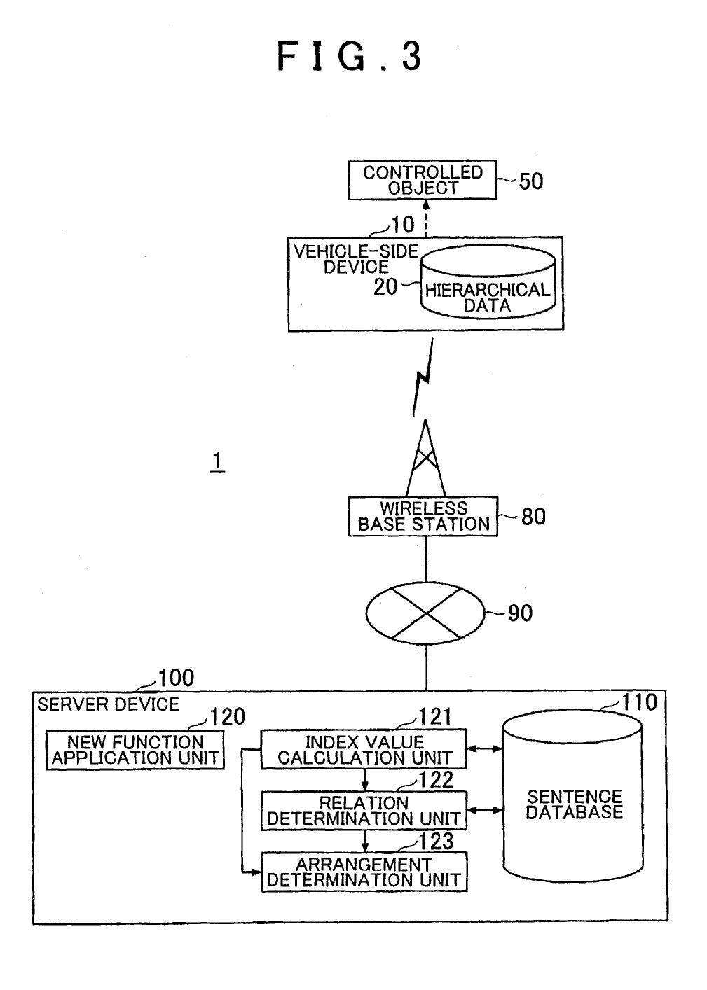

The vehicle-side device 10 controls the controlled object 50. The controlled object 50 is, for example, an in-vehicle audio system or a driving function control system. The vehicle-side device 10 manages functions of the controlled object 50 and software switches displayed on the display device in order to, for example, call and adjust the functions in a hierarchical structure such that the software switches are conceptually in a hierarchical relation or a parallel relation. For example, when the software switch “audio” is touched and selected on a root menu screen, so the software switches, such as “sound quality”, “select source” and “select music”, arranged in the lower level of “audio” are displayed on the screen. Subsequently, when “sound quality” is touched, the software switches, such as “volume” and “treble”, arranged in the lower level of “sound quality” are displayed on the screen. FIG. 2 is a view that shows hierarchical data 20 that are managed by the vehicle-side device 10. The vehicle-side device 10 holds the hierarchical data 20 in the storage unit 13, or the like (see FIG. 3). Here, the conceptually hierarchical relation is a relation in which an upper-level concept incorporates a lower-level concept, and is, for example, a relation between “audio” and “sound quality”. In addition, the conceptually parallel relation is a relation in which a combination having a non-hierarchical relation is incorporated in a common upper-level concept, and is, for example, a relation between “sound quality” and “select source” that are incorporated in the common upper-level concept “audio” (see FIG. 2).

When a new function, such as “i-Pod (trademark)”, is added to such hierarchical data, the vehicle-side device 10 determines a new function and the arrangement of the software switch on the basis of information from the server device 100. The time when a new function is added is more specifically the time when an application program, or the like, associated with the new function has been installed through communication or the time when a storage medium, such as a CD, has been distributed and an application program, or the like, has been installed.

FIG. 3 is an example of the functional configuration of the system 1 for implementing the above-described functions. As described above, the vehicle-side device 10 stores the hierarchical data 20 in the storage unit 13, or the like. The hierarchical data 20 are ones that the names of the above-described functions and software switches are stored as word data having a hierarchical structure. That is, the hierarchical data 20 include words corresponding to the names and data in which a relation between words is conceptually defined in a conceptually hierarchical structure.

The server device 100 includes a new function application unit 120, an index value calculation unit 121, a relation determination unit 122 and an arrangement determination unit 123 as functional units that function as the CPU 101 executes programs stored in the storage unit 105. The functional units may not be implemented by distinctly independent programs, and may be sub-routines or functions that are called from other programs. Parts of the functional units may be hardware means, such as a large scale integrated circuit (LSI), an integrated circuit (IC) and a field programmable gate array (FPGA).

The server device 100 holds a sentence database 110, as data for cross-relation determination, in the storage unit 105. The sentence database 110, for example, stores a plurality of sentences, and manages the plurality of sentences page by page. The page, for example, corresponds to one page in a web site, a newspaper account in a newspaper, or the like. The sentence database 110 may be collected from any source as long as the source has universality.

The new function application unit 120, at the time of adding a new function to the vehicle-side device 10 as described above, transmits the program for implementing the intended new function to the vehicle-side device 10. The function of adding a new function may be included in a device other than the server device 100. In the present embodiment, the server device 100 has the function of adding a new function to the vehicle-side device 10 and the function of determining a place in which a new function is arranged in the hierarchical structure by determining a relation between words.

The index value calculation unit 121 calculates an index value that indicates a relevance ratio on a combination between a newly added word that indicates a new function (“i-Pod” in the above) and each word included in the hierarchical data 20 managed by the vehicle-side device 10. The hierarchical data 20 may be acquired by the server device 100 from the vehicle-side device 10 through communication, and may be held by the server device 100 model by model. The index value calculation unit 121, for example, calculates pointwise mutual information (PMI) expressed by the mathematical expression (1) or a value obtained by correcting PMI as an index value that indicates a relevance ratio between words. Here, “correction” means to, for example, add a correction term to a PMI calculation expression in form of four arithmetic operations or a power. In the mathematical expression (1), f(a, b) is the number of sentences that include both word a and word b in the sentence database 110, and N(a, b) is the total number of sentences in a page in which a sentence that includes both word a and word b is present (where there are a plurality of such pages, the sum of the total number of sentences in each page) in the sentence database 110. N(a, b) may be the total number of sentences in the sentence database 110 when the sentence database 110 is not originally managed page by page, or, when the sentence database. 110 is managed genre by genre, may be the total number of sentences included in the intended genre in the sentence database 110. P(a) is f(a)/N(a, b). Here, f(a) is the number of sentences that include word a in the sentence database 110. Similarly, P(b) is f(b)/N(a, b). Here, f(b) is the number of sentences that include word b in the sentence database 110. P(a, b) is f(a, b)/N(a, b).

$$P M I = \frac{P ( a , b )}{P ( a ) \cdot P ( b )} \cdot \frac{f ( a , b )}{f ( a , b ) + 1} \cdot \frac{min ( f ( a ) , f ( b ) )}{min ( f ( a ) , f ( b ) ) + 1} \qquad ( 1 )$$

An index value of another type may be employed as an index value that indicates a relevance ratio between words instead of PMI or corrected PMI.

The relation determination unit 122 determines whether a combination of words of which the index value calculated by the index value calculation unit 121 is larger than or equal to a threshold (for example, 50), that is, a combination of words having a high relevance, is conceptually in a hierarchical relation or in a parallel relation.

The relation determination unit 122 calculates the number of times specific words have appeared between two words in the sentence database 110, and determines whether the two words are conceptually in a hierarchical relation or in a parallel relation on the basis of on which side the position of a coordinate having the calculated number of times as a coordinate value in an imaginary space of which the axis represents the number of appearances of the specific words is present with respect to separating hyperplanes determined by a support vector machine in advance. Determination of the separating hyperplanes with the use of the support vector machine will be described later. The specific words are words, such as “and”, “in”, “among”, “together with”, or the like, that are highly likely to appear between two words when the two words are in a hierarchical relation or in a parallel relation. The specific words used are effective words determined through verification using teacher data in advance. Thus, it is possible to appropriately determine a relation between words in a hierarchical structure.

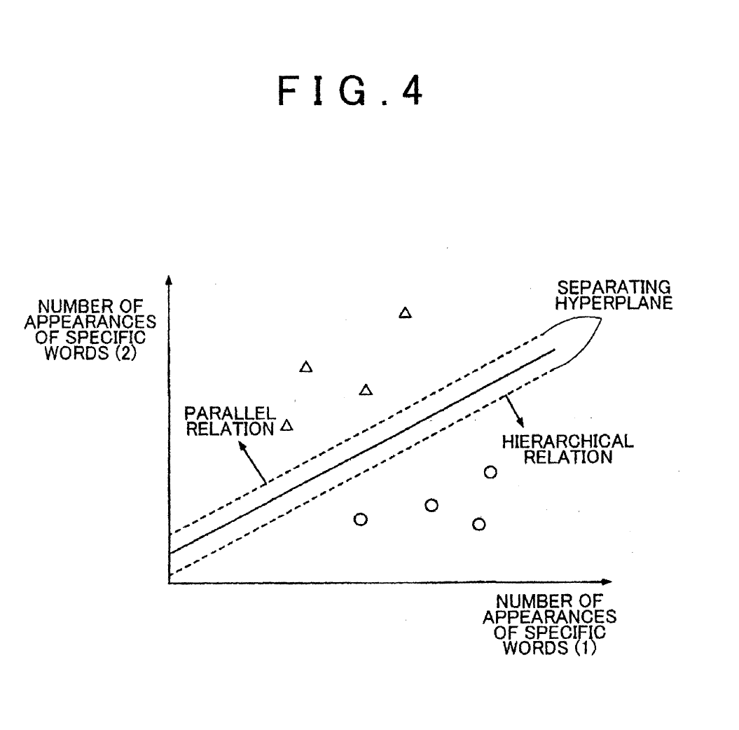

FIG. 4 is an image view that conceptually shows determination made by the relation determination unit 122 as to whether two words are conceptually in a hierarchical relation or in a parallel relation. FIG. 4 shows the imaginary space in a two-dimensional space of which the number of axes that indicate the number of appearances of the specific words is two; however, the number of axes is not limited to two.

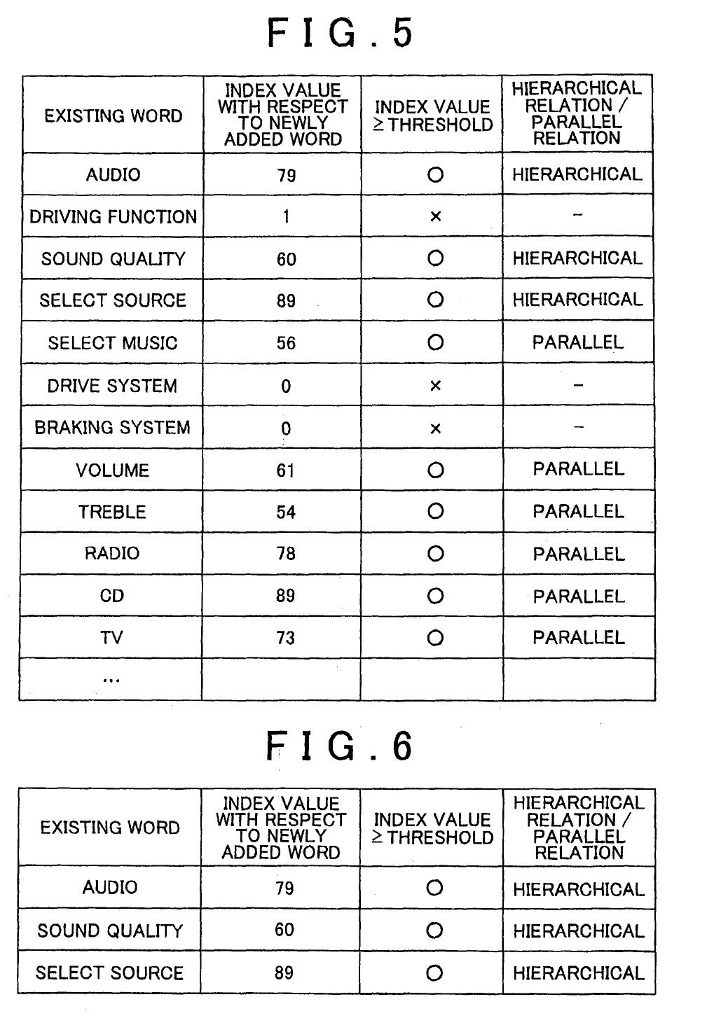

When determination is made by the relation determination unit 122, the index value calculated by the index value calculation unit 121 and the processing result indicating a hierarchical relation or a parallel relation are output. FIG. 5 is an example of processing results on a combination between the newly added word “i-Pod” and each word included in the hierarchical data 20.

The arrangement determination unit 123 determines “arrangement of a new function in the hierarchical data” on which the vehicle-side device 10 is instructed using the processing results obtained by the index value calculation unit 121 and the relation determination unit 122, and transmits the “arrangement of a new function in the hierarchical data” to the vehicle-side device 10.

Initially, the arrangement determination unit 123 extracts upper-level candidate words-of-which the index value calculated-for -a combination- with the newly added word “i-Pod” is larger than or equal to the threshold and that are in a hierarchical relation with the newly added word. FIG. 6 is an example of the upper-level candidate words extracted by the arrangement determination unit 123 on the basis of the processing results shown in FIG. 5.

Subsequently, the arrangement determination unit 123 determines which upper-level candidate word the newly added word should be arranged in the lower level on the basis of the index value between each word arranged in the lower level of the extracted upper-level candidate words and the newly added word in accordance with a predetermined rule. A plurality of methods can be employed for a method of determining such arrangement, and these are listed below. Hereinafter, for a word determined to be in the “hierarchical relation” with the newly added word, an index value* to be used as a determination reference is set to zero (because the index value is limited to the parallel relation).

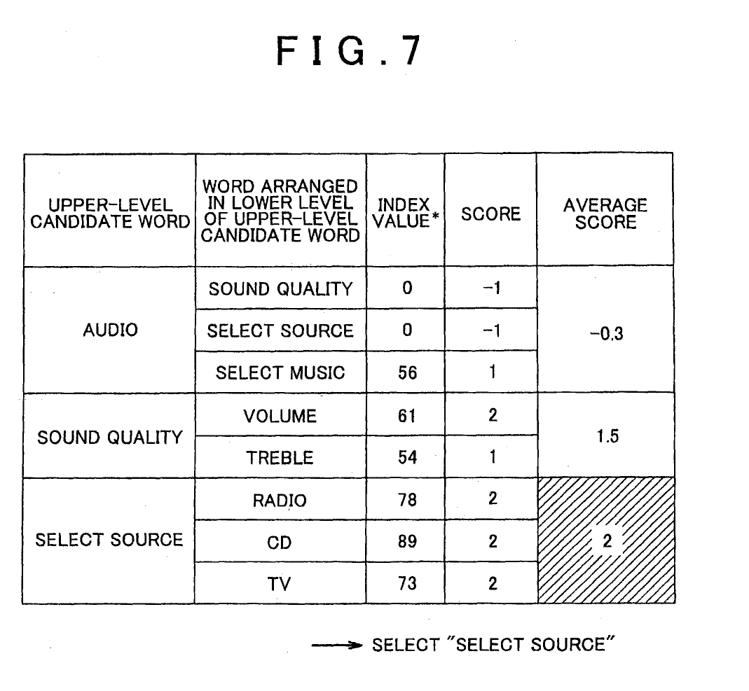

Method (1): The arrangement determination unit 123, for example, calculates a score as “−1” when the index value* is smaller than 30, “1” when the index value* is larger than or equal to 30 and smaller than 60 and “2” when the index value* is larger than or equal to 60, obtains the average of scores calculated for the words arranged in the lower level for each upper-level candidate word, and arranges the newly added word in the lower level of the upper-level candidate word having the highest average value. FIG. 7 is a view that shows a state where the arrangement determination unit 123 determines arrangement of the newly added word on the basis of the average score.

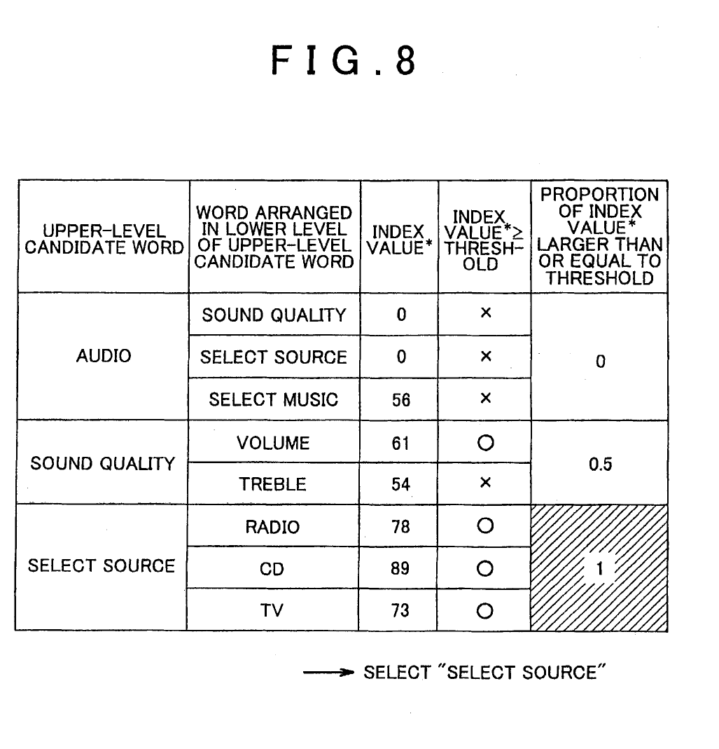

Method (2): The arrangement determination unit 123, for example, obtains the proportion of the index value* that is calculated for each word arranged in the lower level and that is larger than or equal to a threshold (for example, 60) for each upper-level candidate word, and arranges the newly added word in the lower level of the upper-level candidate word having the highest proportion. The “threshold” here may be different from the “threshold” that is used at the time when the relation determination unit 122 determines whether it is a combination of words having a high relevance. FIG. 8 is a view that-shows a state where the arrangement determination unit 123 arranges the newly added word in the lower level of the upper-level candidate word having the highest proportion of the index value* larger than or equal to the threshold. In FIG. 8, “O” is assigned to words of which the index value* is larger than or equal to the threshold, and “×” is assigned to words of which the index value* is smaller than the threshold.

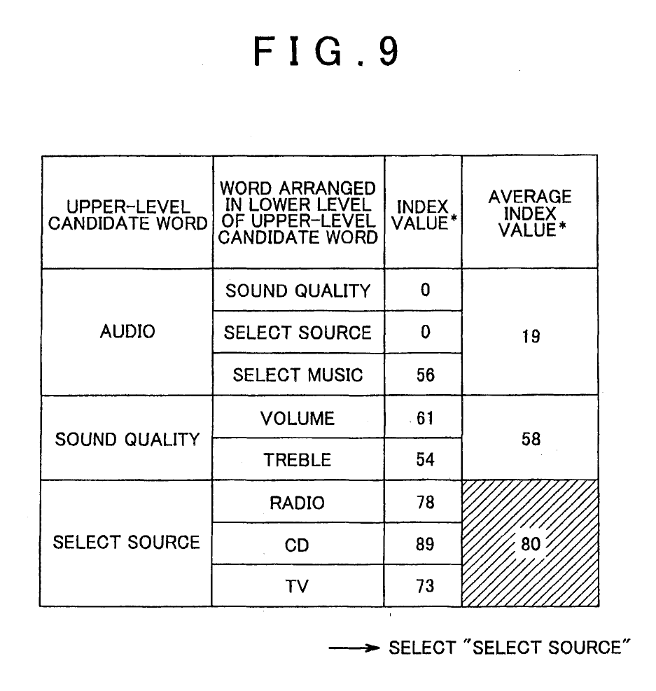

Method (3): The arrangement determination unit 123, for example, obtains the average of index values* calculated for the words arranged in the lower level for each upper-level candidate word, and arranges the newly added word to the lower level of the upper-level candidate word having the largest average value. FIG. 9 is a view that shows a state where the arrangement determination unit 123 arranges the newly added word to the lower level of the upper-level candidate word having the largest average of the index values*.

Method (4): The arrangement determination unit 123, for example, arranges the newly added word to the lower level of the upper-level candidate word of which the number of words having the score “−1” in the method (1) is small (not shown).

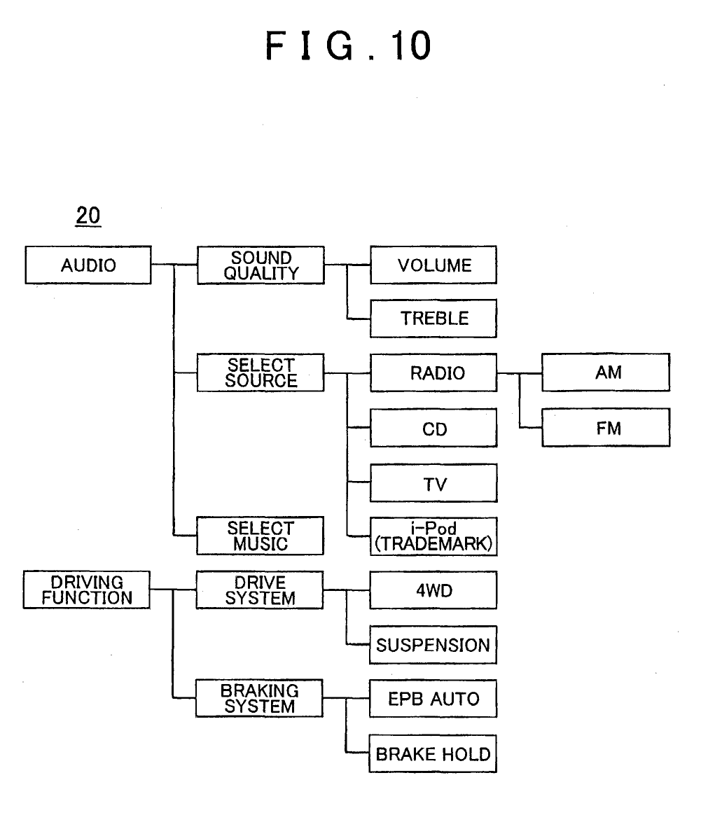

FIG. 10 is a view that shows a state where the newly added word “i-Pod” is arranged in the lower level of “select source” with the use of any one of the methods.

When the arrangement determination unit 123, for example, determines arrangement of the newly added word with the use of the above-listed methods, the arrangement determination unit 123 transmits the determined arrangement to the vehicle-side device 10. Here, arrangement of the newly added word is not necessarily determined at one location. For example, when a plurality of arrangements having a high value are derived by the above-listed methods, arrangement at multiple locations is also allowed (for example, the newly added word “i-Pod” is arranged in both the lower level of “audio”, and the lower level of “sound quality”). The vehicle-side device 10 guides the user for a hierarchical position of the newly set software switch with the use of the output unit 17.

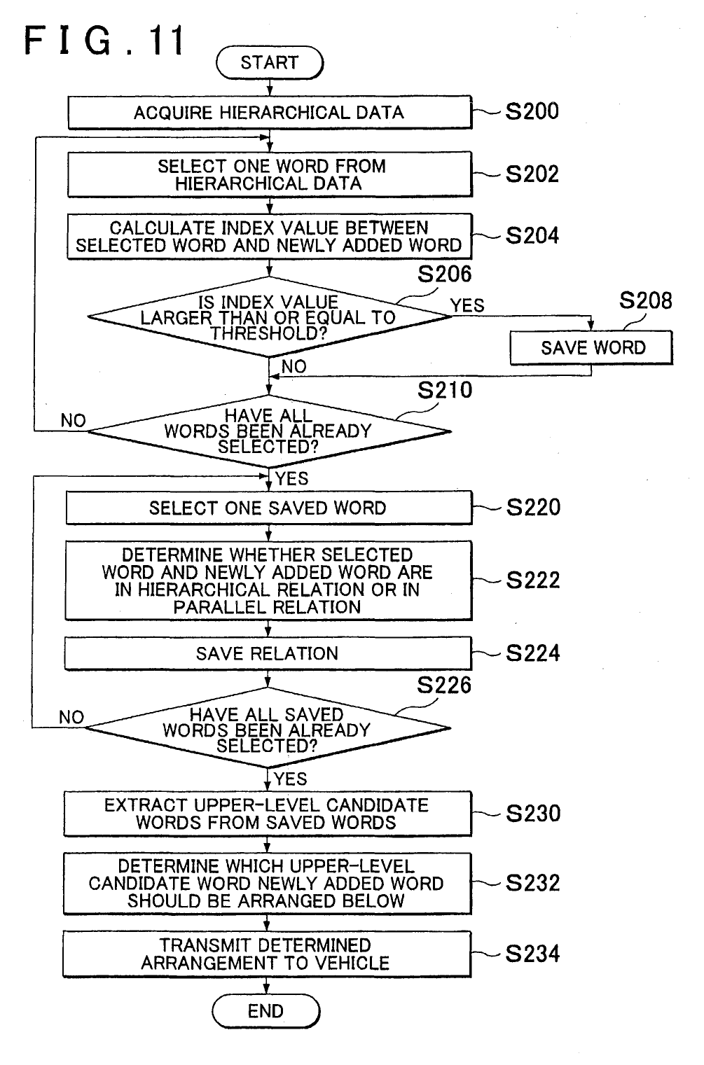

FIG. 11 is an example of the flowchart that shows the flow of processes that are executed by the server device 100 according to the present embodiment. The flowchart is started when there occurs an event that a new function is added to the vehicle-side device 10 by the new function application unit 120.

Initially, the index value calculation unit 121 acquires the hierarchical data 20 from the vehicle-side device 10.

Subsequently, the index value calculation unit 121 selects one word from the hierarchical data 20 (for example, in order from the first) (S202).

After that, the index value calculation unit 121 calculates an index value between the word selected in S202 and the newly added word (S204), and determines whether the index value is larger than or equal to the threshold (S206). When the index value is larger than or equal to the threshold, the index value calculation unit 121 saves the word in the memory unit 104, or the like (S208).

After completion of the processes of S206 to S208, the index value calculation unit 121 determines whether all the words have been selected from the hierarchical data 20 (S210). When all the words have not been selected yet, the index value calculation unit 121 returns to S202, and selects the next word.

When the index value calculation unit 121 has selected and processed all the words, the relation determination unit 122 selects one word saved in S208 (for example, in order from the first) (S220).

Subsequently, the relation determination unit 122 determines whether the word selected in S220 and the newly added word are in a hierarchical relation or in a parallel relation (S222), and saves the determined relation in the memory unit 104, or the like (S224).

When the relation determination unit 122 has completed the process of S224, the relation determination unit 122 determines whether all the words saved in S208 have been selected (S226). When all the words have not been selected yet, the relation determination unit 122 returns to S220, and selects the next word.

When the relation determination unit 122 has selected and processed all the words, the arrangement determination unit 123 extracts upper-level candidate words from among the saved words (S230), determines which upper-level candidate word the newly added word should be arranged below-with the use of-the above-described methods (S232), and transmits the determined arrangement to the vehicle (S234).

Here, determination of the separating hyperplanes with the use of the support vector machine will be described. Here, when the two words are in a hierarchical relation or in a parallel relation as described above, the number of appearances of a plurality of specific words that are highly likely to appear between words, expressed in vector format, is referred to as feature vector x. A recognition target class required in the present embodiment includes two types, that is, a hierarchical relation and a parallel relation, so there are two classes, that is, “+1” and “−1”. It is possible to learn a stochastic correspondence relation between a feature vector (the number of appearances of the specific words) and the class (the hierarchical relation or the parallel relation) from known teacher data with the use of the support vector machine, and, with the use of the separating hyperplanes that are obtained as the learned result, to determine which class the relation between the input words belongs to on the basis of the relation between the number of appearances of the specific words present between the input words and the separating hyperplanes.

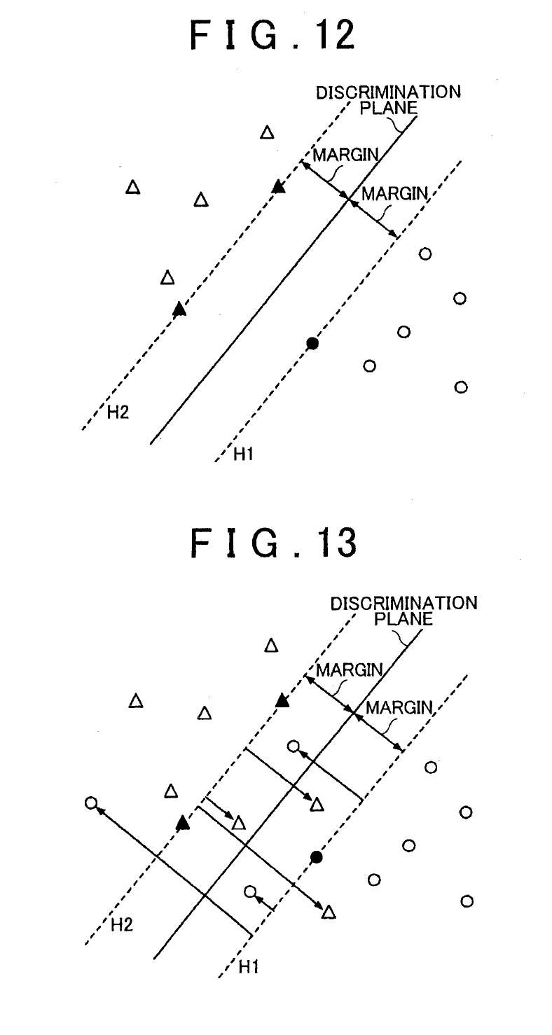

The support vector machine obtains optimal parameters for the purpose of maximizing a margin on the basis of the teacher data. FIG. 12 is a view that simply shows the relationship among data included in the teacher data, the separating hyperplanes, the margin and the support vector in two-dimensional space form. In FIG. 12, the outlined circles indicate data of class “+1”, the outlined triangles indicate data of class “4” and the solid circle and the solid triangles indicate the support vector.

When the teacher data are linearly separable and the teacher data are completely separable by two separating hyperplanes, that is, H1 and H2, the mathematical expression (2) holds. In the mathematical expression (2), N is the number of teacher data, and tᵢ is the class of each of data (1, 2, . . . , N) included in the teacher data. H1 and H2 are respectively expressed by the mathematical expression (3) and the mathematical expression (4).

tᵢ(w^{T}xᵢ+b)≧1, i=1, . . . , N (2)

H1: w^{T}x+b=1 (3)

H2: w^{T}x+b=−1 (4)

The size of the margin, that is, the distance between a discrimination plane and each of the separating hyperplanes is expressed by the following mathematical expression (A).

$$\frac{1}{‖ w ‖} \qquad ( A )$$

Thus, by setting the mathematical expression (2) as restriction condition and obtaining optimal parameters (feature vector w, feature vector b) that minimize an objective function (5), it is possible to obtain the maximum margin. The optimization problem is already known as a quadratic programming problem in mathematical programming, and various methods are known, so the description is omitted.

$$L ( w ) = \frac{1}{2} {‖ w ‖}^{2} \qquad ( 5 )$$

It is ideal that all the teacher data are separable by the separating hyperplanes; however, actually, the goodness of fit is highly likely to improve when a small number of teacher data are allowed to enter an opposite side. A method of obtaining the separating hyperplanes by relaxing restrictions in this way is called soft margin.

When the soft margin is employed, part of teacher data are allowed to enter the opposite side beyond the separating hyperplane H1 or the separating hyperplane H2. FIG. 13 is a view that simply shows the relationship among data included in teacher data, separating hyperplanes, a margin and a support vector in a two-dimensional space form in the case where the soft margin is employed.

Here, the distance by which part of teacher data enter the opposite side is expressed by the following mathematical expression (B).

$$\frac{{ζ}_{i}}{‖ w ‖} \qquad ( B )$$

Thus, the optimization problem is modified into a problem for obtaining optimal parameters (feature vector w, feature vector b) that use the mathematical expression (6) as the restriction condition and that minimize the objective function (7). In the mathematical expression (6), a parameter y is a value that determines how far part of the teacher data are allowed to enter with respect to the size of the margin.

$$\begin{matrix}{ζ}_{i} \geq 0 , {t}_{i} ( {w}^{T} {x}_{i} + b ) \geq 1 - {ζ}_{i} , ( i = 1 , … N ) & ( 6 ) \\ L ( w , ζ ) = \frac{1}{2} {‖ w ‖}^{2} + γ {\sum }_{i = 1}^{N} {ζ}_{i} & ( 7 )\end{matrix}$$

In the support vector machine, there is further a method of nonlinearly converting a feature vector and linearly discriminating the space, and this method is called kernel trick. By employing kernel trick, it is possible to improve the accuracy of the support vector machine. The specific method of the kernel trick is already known, so the description is omitted.

According to the above-described embodiment, the number of times the specific words have appeared between input two words is calculated for the sentence database 110. Furthermore, it is determined whether two words are conceptually in a hierarchical relation or in a parallel relation on the basis of the position of a coordinate having a coordinate value that is the calculated number of times in the imaginary space having the axis that represents the number of appearances of the specific words. Therefore, it is possible to appropriately determine the relation between words in the hierarchical structure.

The applicant of the present application compared the processing results of the device according to the present embodiment with psychological values obtained through evaluation on object data, conducted by a human, and confirmed that there is a correlativity of a certain degree.

With the cross-language relevance determination device and the cross-language relevance determination program according to the present embodiment, by calculating an index value between the newly added word and each word included in the hierarchical data 20 and making relation determination on the hierarchical data 20, it is possible to arrange the newly added word at an appropriate place in the hierarchical data 20 on the basis of the result of the relation determination. As described above, in the case where the vehicle is set as an object, the hierarchical data 20 differ among the vehicles, so, even when the same new function is added to different models, it is possible to automatically determine where the newly added word is arranged in the hierarchical data 20 of each vehicle, so it is desirable.

It is possible to utilize the method according to the first embodiment not only in a scene in which the hierarchical data 20 have been already established but also when the hierarchical data 20 are newly constructed in a development phase. It is possible to not only arrange the newly added word in the hierarchical data 20 but also rearrange the hierarchical data 20 themselves.

### Second Embodiment

Hereinafter, a system 2 according to a second embodiment will be described. The system 2 according to the second embodiment includes the vehicle-side device 10 and the server device 100. The hardware configuration is the same as that of the first embodiment, so FIG. 1 is used, and the illustration is omitted.

The vehicle-side device 10 according to the second embodiment has, for example, a navigation function and a function of controlling an air conditioner and an audio device, and, as in the case of the first embodiment, hierarchically manages a command for calling each function from a user. Thus, the vehicle-side device 10 according to the second embodiment holds the hierarchical data 20 in the storage unit 13, or the like, as in the case of the first embodiment. The vehicle-side device 10 has the function of allowing a command to be input through a software switch on a touch panel and accepting a voice command by recognizing voice that is input through a microphone.

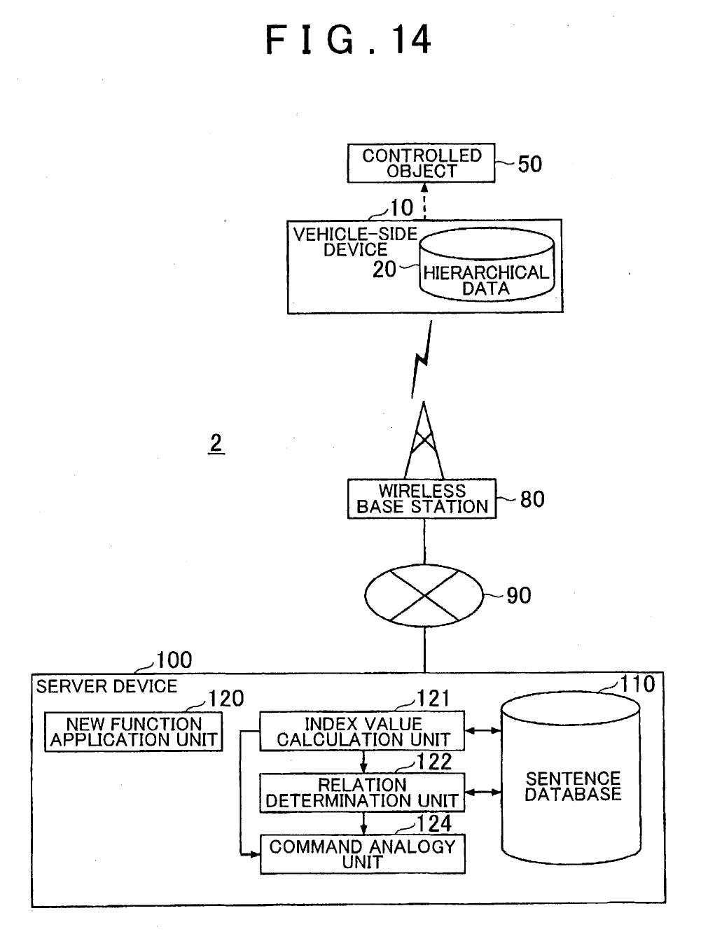

FIG. 14 is an example of the functional configuration of the system 2. The server device 100 according to the second embodiment includes the index value calculation unit 121, the relation determination unit 122 and a command analogy unit 124 as functional units that function as the CPU 101 executes programs stored in the storage unit 105. The functional units may not be implemented by distinctly independent programs, and may be sub-routines or functions that are called from other programs. Parts of the functional units may be hardware means, such as an LSI, an IC and an FPGA.

When the recognized result of voice spoken by the user agrees to the word included in the hierarchical data 20, the vehicle-side device 10 according to the second embodiment launches the function corresponding to the intended command. On the other hand, when the recognized result of voice spoken by the user does not agree to the word included in the hierarchical data 20, the vehicle-side device 10 according to the second embodiment transmits the recognized result of voice and the hierarchical data 20 to the server device 100, and receives and executes a command estimated by the server device 100.

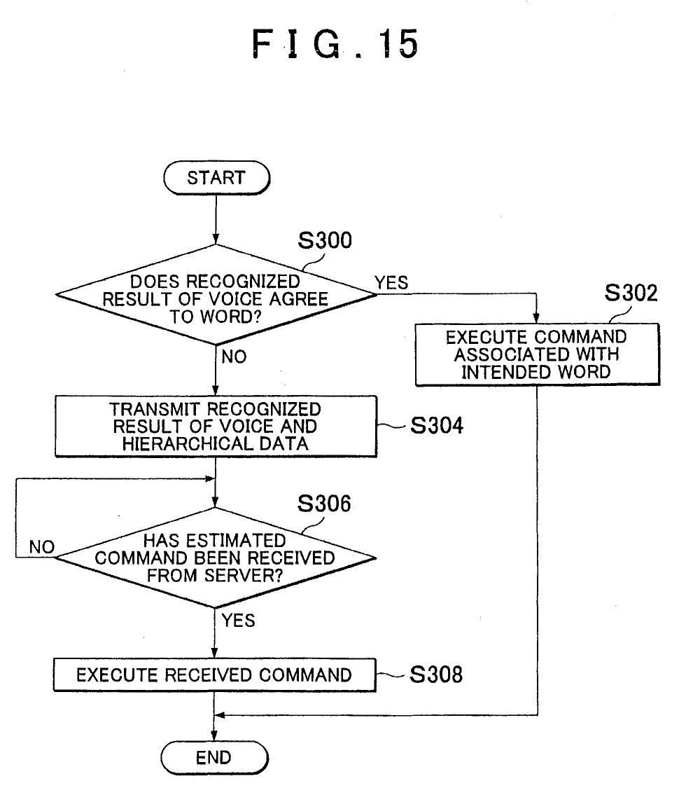

FIG. 15 is an example of the flowchart that shows the flow of processes that are executed by the vehicle-side device 10 according to the second embodiment. The flowchart is started when voice spoken by the user is recognized.

Initially, the vehicle-side device 10 determines whether the recognized result of voice agrees to the word included in the hierarchical data 20 (S300). When the recognized result of voice agrees to the word included in the hierarchical data 20, the command associated with the intended word is executed (S302).

On the other hand, when the recognized result of voice does not agree to the word included in the hierarchical data 20, the vehicle-side device 10 transmits the recognized result of voice and the hierarchical data 20 to the server device 100 (S304), and waits until it receives an estimated command (S306).

When the vehicle-side device 10 receives the estimated command, the vehicle-side device 10 executes the received command (S308).

When the server device 100 according to the second embodiment receives the recognized result of voice and the hierarchical data 20, the index value calculation unit 121 and the relation determination unit 122 execute processes equivalent to the processes of S200 to S226 in FIG. 11.

Initially, the index value calculation unit 121 calculates an index value that indicates a relevance ratio for a combination of the recognized result of voice and each word included in the hierarchical data 20 as in the case of the first embodiment.

The relation determination unit 122 determines whether a combination of words having the index value that is calculated by the index value calculation unit 121 and that is larger than or equal to a threshold (for example, 50), that is, a combination of words having a high relevance, is conceptually in a hierarchical relation or in a parallel relation.

The command analogy unit 124 analogizes the word having the highest index value among the words that are in a parallel relation with the recognized result of voice as a voice command issued to the vehicle-side device, and transmits the analogized word to the vehicle-side device 10. For example, when the recognized result of voice is “destination” and the word included in the hierarchical data 20 is “goal”, “current location”, “air conditioner”, “audio”, or the like, it is assumed that the index value that is calculated for “goal” is the highest, the index value that is calculated for “current location” is intermediate and the index value that is calculated for “air conditioner” or “audio” is close to zero, the command analogy unit 124 determines that the voice command of the user may be regarded as “goal”.

With the cross-language relevance determination device and cross-language relevance determination program according to the above-described embodiment, the number of times the specific words have appeared between input two words is calculated for the sentence database 110. Furthermore, it is determined whether two words are conceptually in a hierarchical relation or in a parallel relation on the basis of the position of a coordinate having a coordinate value that is the calculated number of times in the imaginary space having the axis that represents the number of appearances of the specific words. Therefore, it is possible to appropriately determine the relation between words in the hierarchical structure.

According to the present embodiment, by calculating an index value between the recognized result of voice spoken by the user and each word included in the hierarchical data 20 and making relation determination on the hierarchical data 20, it is possible to cause the vehicle-side device 10 to execute an appropriately analogized command on the basis of the result even when user's speech is not present in existing commands.

### Third Embodiment

Hereinafter, a system 3 according to a third embodiment will be described.

The system 3 according to the third embodiment includes the vehicle-side device 10 and the server device 100. The hardware configuration is the same as that of the first embodiment, so FIG. 1 is used, and the illustration is omitted.

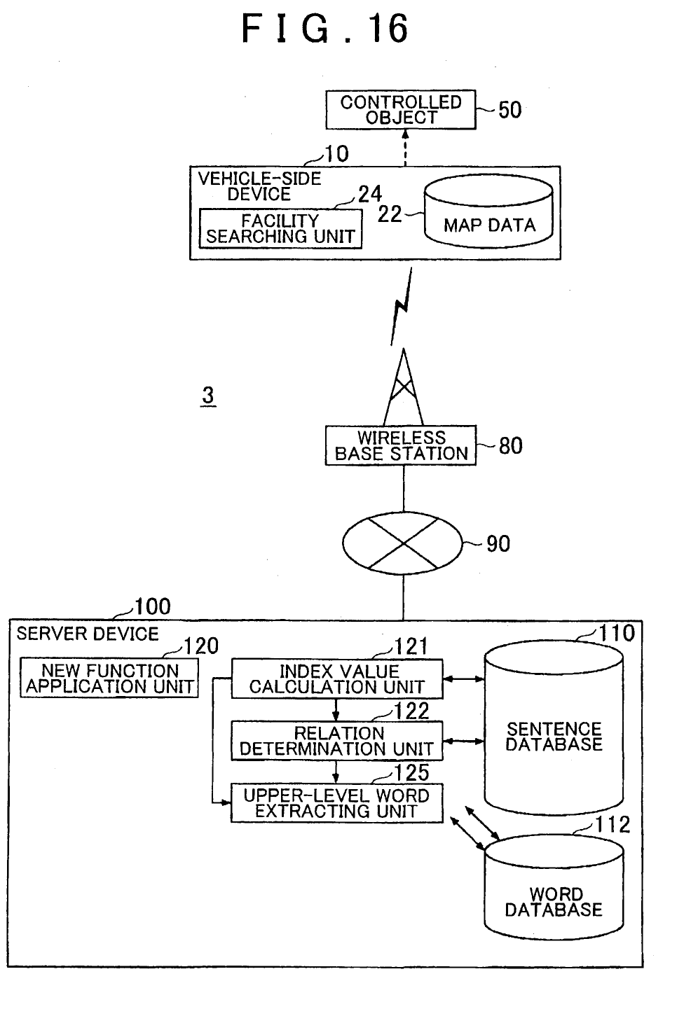

FIG. 16 is an example of the functional configuration of the system 3. The server device 100 according to the third embodiment includes the index value calculation unit 121, the relation determination unit 122 and an upper-level word extracting unit 125 as functional units that function as the CPU 101 executes programs stored in the storage unit 105. The functional units may not be implemented by distinctly independent programs, and may be sub-routines or functions that are called from other programs. Parts of the functional units may be hardware means, such as an LSI, an IC and an FPGA. In addition, the server device 100 according to the third embodiment holds a word database 112 storing a word group in the storage unit 105, or the like, in addition to the sentence database 110. The word database 112 is desirably created by data that are a collection of words that are highly likely to be used to search for a facility within a range of facility information that is included in map data 22.

The vehicle-side device 10 according to the third embodiment is a navigation system, and includes the function of storing the map data 22, including facility information, in the storage unit 13 and obtaining the current location of the vehicle on the basis of a GPS signal, the function of providing an optimal route to the goal to the user, and a functional unit (facility searching unit 24) that searches for the map data 22 whether the facility input by the user is present around the vehicle and that indicates the location of the facility to the user.

The vehicle-side device 10 according to the third embodiment, as well as the second embodiment, has the function of recognizing voice spoken by the user. When the facility indicated by the recognized result of voice is present in the map data 22, the facility searching unit 24 provides information about the intended facility to the user with the use of the output unit 17.

When the facility indicated by the recognized result of voice spoken by the user is not present in the map data 22, the user makes a speech for the second time and the facility indicated by the recognized result of voice associated with the second speech is also not present in the map data 22, the facility searching unit 24 transmits the first and second recognized results of voice to the server device 100.

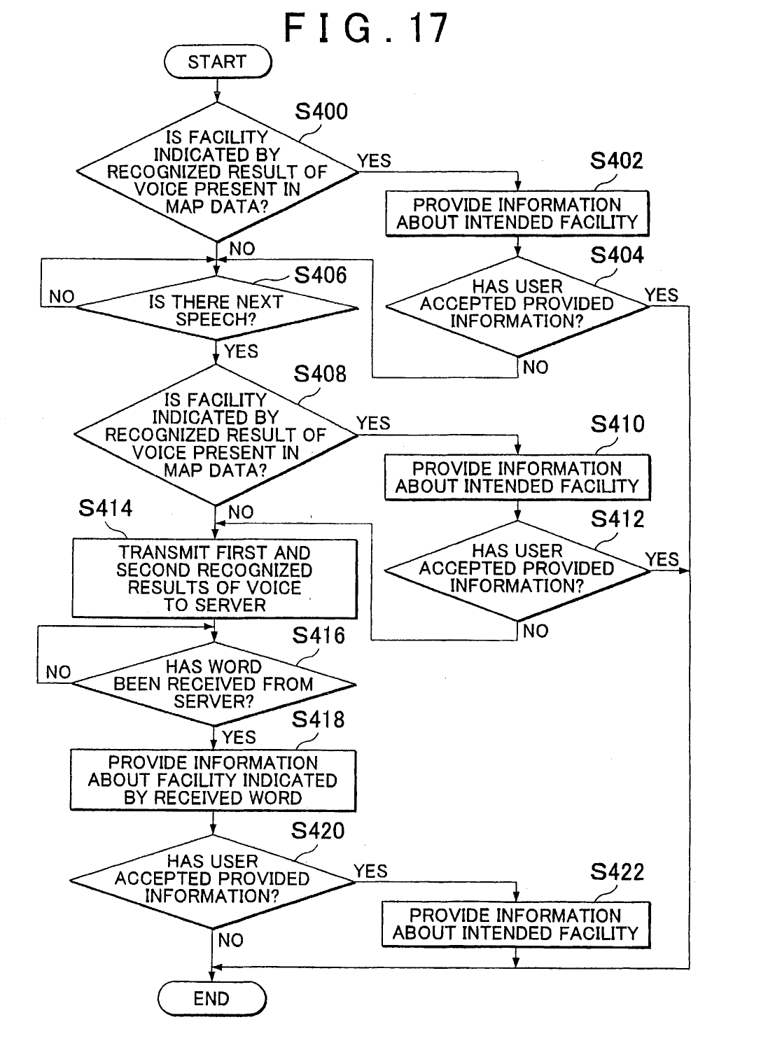

FIG. 17 is an example of the flowchart that shows the flow of processes that are executed by the vehicle-side device 10 according to the third embodiment. The flowchart is started when voice spoken by the user is recognized.

Initially, the facility searching unit 24 determines whether a facility indicated by the recognized result of voice spoken by the user is present in the map data 22 (S400). When the facility indicated by the recognized result of voice spoken by the user is present in the map data 22, the facility searching unit 24 provides information about the intended facility to the user with the use of the output unit 17 (S402). The facility searching unit 24 determines whether the user has conducted operation to accept the provided information (or voice input) (S404). When the provided information has not been accepted, the process proceeds to S406; whereas, when the provided information has been accepted, the flowchart shown in FIG. 17 is ended.

When the facility indicated by the recognized result of voice spoken by the user is not present in the map data 22 or when negative determination is made in S404, the facility searching unit 24 waits until the user makes the next speech (S406). When the user has made the next speech, the facility searching unit 24 determines whether the facility indicated by the recognized result of voice spoken by the user is present in the map data 22 (S408). When the facility indicated by the recognized result of voice spoken by the user is present in the map data 22, the facility searching unit 24 provides information about the intended facility to the user with the use of the output unit 17 (S410). The facility searching unit 24 determines whether the user has conducted operation to accept the provided information (or voice input)(S412). When the provided information has not been accepted, the process proceeds to S414; whereas, when the provided information has been accepted, the flowchart shown in FIG. 17 is ended.

When the facility indicated by the recognized result of voice spoken by the user is not present in the map data 22 or negative determination is made in step 5412 in the second speech as well, the facility searching unit 24 transmits the first and second recognized results of voice to the server device 100 (S414).

The facility searching unit 24 waits until it receives a word from the server device 100 (S416). When the facility searching unit 24 receives a word, the facility searching unit 24 provides information about a facility indicated by the received word (which can be plural) to the user with the use of the output unit 17 (S418).

Subsequently, the facility searching unit 24 determines whether the user has conducted operation to accept the provided information (any one of the pieces of provided information in the case where there are plural received words) (or voice input) (S420). When the provided information has been accepted, the facility searching unit 24 provides information about the facility to the user with the use of the output unit 17 (S422).

When the provided information has not been received, the facility searching unit 24 may end the process of the flowchart and resume the process from the next speech or may wait for the third speech and transmit the first to third recognized results of voice associated with speech to the server device 100.

In the server device 100 according to the third embodiment, when the recognized results of voice have been received, the index value calculation unit 121 and the relation determination unit 122 execute the processes equivalent to the processes of S200 to S226 in FIG. 11 on the recognized result (1) of voice and each word included in the word database 112 and further on the recognized result (2) of voice and each word included in the word database 112.

The upper-level word extracting unit 125 extracts an upper-level word that has the index value larger than or equal to the threshold and that is in a hierarchical relation with the recognized result (1) of voice and that has the index value larger than or equal to the threshold and that is in a hierarchical relation with the recognized result (2) of voice, and transmits the upper-level word to the vehicle-side device 10. For example, when the recognized result (1) of voice is “pasta” and the recognized result (2) of voice is “pizza”, it is assumed that an upper level word like “Italian” is extracted. When the recognized result (1) of voice is “pasta” and the recognized result (2) of voice is “ramen”, it is assumed that an upper level word like “noodles” is extracted.

Through such a process, when voice spoken by the user is too narrower than attached facility information in the map data 22, a conceptually upper-level word is extracted (it is less likely that a common lower-level word is extracted), so it is possible to increase the possibility that the user is able to acquire facility information from the map data 22.

According to the above-described embodiment, the number of times the specific words have appeared between input two words is calculated for the sentence database 110. Furthermore, it is determined whether two words are conceptually in a hierarchical relation or in a parallel relation on the basis of the position of a coordinate having a coordinate value that is the calculated number of times in the imaginary space having the axis that represents the number of appearances of the specific words. Therefore, it is possible to appropriately determine the relation between words in the hierarchical structure.

According to the present embodiment, a conceptually upper-level word with voice spoken by the user is extracted, so it is possible to increase the possibility that the user is able to acquire facility information from the map data 22.

A mode for carrying out the invention is described using the embodiments; however, the invention is not limited to such embodiments. The invention may be implemented by adding various modifications or replacements without departing from the scope of the invention.

For example, in the first and second embodiments, the subject of the process is the server device 100; instead, the subject of the process may be arranged at the vehicle side. In this case, the vehicle may access the sentence database via the Internet, or the like, or may hold the sentence database in the vehicle.

Similarly, the process of the third embodiment may be completed in the vehicle-side device 10. In this case, the CPU 11 of the vehicle-side device 10 just needs to implement the functional units equivalent to the index value calculation unit 121, the relation determination unit 122 and the upper-level word extracting unit 125, and the vehicle-side device 10 just needs to hold data similar to the word database 112. Furthermore, in this case, the subject of the process does not need to be an in-vehicle device; instead, any device, such as a personal computer, a mobile phone and another embedded computer, may implement the functional units equivalent to the index value calculation unit 121, the relation determination unit 122 and the upper-level word extracting unit 125.

In the first and second embodiments, the hierarchical data 20 that are the processing object of the server device 100 do not need to be held in the vehicle; instead, any device, such as a personal computer, a mobile phone and another embedded computer, may be set as an object. A computer may be configured as a device that obtains the relation between hierarchical data and each word as an internal process.

In the above-described embodiments, handling of the index value after a process is executed using the index value is not described; however, when the index value is saved, it may be utilized to estimate a process that the user originally intends to execute and to suggest operation, for example, when the user has conducted miss operation,

1. A cross-language relevance determination device comprising:
a first database that stores data including a plurality of sentences; and
a relation determination unit that calculates the number of times a specific word has appeared between input two words in the first database, and that determines whether the two words are conceptually in a hierarchical relation or in a parallel relation on the basis of a position of a coordinate having the calculated number of times as a coordinate value in an imaginary space having an axis that represents the number of appearances of the specific word.

2. The cross-language relevance determination device according to claim 1, wherein the relation determination unit determines whether the two words are conceptually in a hierarchical relation or in a parallel relation on the basis of on which side the position of a coordinate having the calculated number of times as a coordinate value in the imaginary space is present with respect to a separating hyperplane determined by a support vector machine in advance.

3. The cross-language relevance determination device according to claim 1, further comprising:
an index value calculation unit that calculates an index value indicating a relevance ratio between the input two words.

4. The cross-language relevance determination device according to claim 3, further comprising:
a second database that includes second words and data that conceptually define a relation between the second words in a hierarchical structure; and
an arrangement determination unit that determines a position at which a newly input word is arranged within the hierarchical structure of the second database, wherein
the two words are respectively the newly input word and each second word, and
the arrangement determination unit determines the position at which the newly input word is arranged in the hierarchical structure of the second database on the basis of a result determined by the relation determination unit and a magnitude of the index value that is calculated by the index value calculation unit.

5. The cross-language relevance determination device according to claim 3, wherein
the index value calculation unit outputs the calculated index value to the relation determination unit, and
the relation determination unit makes determination when the index value input by the index value calculation unit is larger than or equal to a predetermined value.

6. The cross-language relevance determination device according to claim 3, further comprising:
a third database that includes third words and data that conceptually define a relation between the third words in a hierarchical structure; and
a command analogy unit that determines any one of the third words as a command to a device on the basis of a new word input by a user, wherein
the two words are respectively the new word input by the user as the command to the device and each third word, and
the command analogy unit determines the third word having the index value indicating the highest relevancy with the new word among the third words that are conceptually in a parallel relation with the new word as the command to the device.

7. The cross-language relevance determination device according to claim 1, further comprising:
a fourth database that includes fourth words and data that conceptually define a relation between the fourth words in a hierarchically structure; and
an upper-level word extracting unit that determines any one of the fourth words as a keyword for acquiring information on the basis of a plurality of new words input by a user, wherein
the two words are respectively any one of the plurality of new words input by the user as keywords for acquiring the information and each fourth word, and
the upper-level word extracting unit determines any one of the fourth words, which is conceptually in a hierarchical relation with all the plurality of new words, as the keyword for acquiring the information.

8. (canceled)

9. A cross-language relevance determination method comprising:
in a database that stores data including a plurality of sentences, calculating the number of times a specific word has appeared between input two words; and
determining whether the two words are conceptually in a hierarchical relation or in a parallel relation on the basis of a position of a coordinate having the calculated number of times as a coordinate value in an imaginary space having an axis that represents the number of appearances of the specific word.

10. The cross-language relevance determination method according to claim 9, wherein it is determined whether the two words are conceptually in a hierarchical relation or in a parallel relation on the basis of on which side the position of a coordinate having the calculated number of times as a coordinate value in the imaginary space is present with respect to a separating hyperplane determined by a support vector machine in advance.

11. The cross-language relevance determination method according to claim 9, further comprising:
calculating an index value that indicates a relevance ratio between the input two words.

12. The cross-language relevance determination method according to claim 11, further comprising:
making the determination and calculating the index value between an input new word and each word included in a word group of which a relation is defined in a hierarchical structure; and
arranging the new word in the hierarchical structure on the basis of a result of the determination and a magnitude of the index value.

13. The cross-language relevance determination method according to claim 11, wherein
the determination is made when the calculated index value is larger than or equal to a predetermined value.

14. The cross-language relevance determination method according to claim 11, further comprising:
making the determination and calculating the index value between a new word input by a user as a command to a device and each word included in a word group of which a relation is defined in a hierarchical structure; and
determining the word having the index value indicating the highest relevancy with the new word among the words that are in a parallel relation with the new word as the command to the device on the basis of a result of the determination and a magnitude of the index value.

15. The cross-language relevance determination method according to claim 9, further comprising:
making the determination between a plurality of new words input by a user as keywords for acquiring information and each word included a word group of which a relation is defined in a hierarchical structure; and
when there is a word that is in a hierarchical relation with all the plurality of new words, determining the word present in the upper level as a keyword for acquiring the information.

16. A non-transitory computer-readable storage medium storing a program for causing a computer to execute a method, the method comprises:
in a database that stores data including a plurality of sentences, calculating the number of times a specific word has appeared between input two words; and
determining whether the two words are conceptually in a hierarchical relation or in a parallel relation on the basis of a position of a coordinate having the calculated number of times as a coordinate value in an imaginary space having an axis that represents the number of appearances of the specific word.
